(19) United States
(12) Patent Application Publication
(10) Pub. No.: US 2011/0100517 A1
(43) Pub. Date: May 5, 2011

(54) SCOOTER COVER

(76) Inventor: Sandra Bobi Merritt, Sandy, UT (US)

(21) Appl. No.: 12/612,196

(22) Filed: Nov. 4, 2009

(51) Int. Cl. B62J 19/00

(52) U.S. Cl. 150/167

(57) ABSTRACT

A motorcycle, scooter, bicycle, and vehicle cover includes: a cover to protect an upper portion of the vehicle; a first aperture in the cover adapted for the mirror to pass through the first aperture; a first attachment mechanism to secure the device to the vehicle proximate to the first aperture; and a second attachment mechanism to secure the device to the vehicle proximate to the rear

### BACKGROUND OF THE INVENTION

The present invention generally relates to covers, and more specifically, to a scooter cover.

As can be seen, there is a need for a cover for 2-wheeled vehicles.

### SUMMARY OF THE INVENTION

In one aspect of the present invention, a device for a vehicle having an external mirror and a rear includes: a cover to protect an upper portion of the vehicle; a first aperture in the cover adapted for the mirror to pass through the first aperture; a first attachment mechanism to secure the device to the vehicle proximate to the first aperture; and a second attachment mechanism to secure the device to the vehicle proximate to the rear.

In another aspect of the present invention, a method of protecting a two-wheeled vehicle includes: measuring a size of the vehicle; providing a cover adapted to fit the size of the vehicle, the cover having an aperture; aligning the aperture with a handle grip of the vehicle; placing the cover over the vehicle; and closing the cover; thereby protecting the vehicle.

These and other features, aspects and advantages of the present invention will become better understood with reference to the following drawings, description and claims.

### BRIEF DESCRIPTION OF THE DRAWINGS

FIG. 1 depicts an embodiment of the present invention; and

FIG. 2 depicts an embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a compact, easy on/off, cover that protects your scooter from elements in the environment.

An embodiment of the present invention may be used on a regular basis because the invention may be put on and removed, and it can be stored in a small space. An embodiment may eliminate extra wear and tear on a scooter because by covering the scooter's vital parts such as the instrument panel, seat, and motor. The cover may be made of a material that is UV resistant, water repellant, light weight and will not tear even if a hole is punctured into it. The cover allows the scooter rider to return to a scooter that does not have a scalding hot seat or a wet seat due to rain. An embodiment protects the scooter from elements in the environment. Other embodiments apply not only to scooters, but to motorcycles, bicycles, or other vehicles.

An embodiment of the invention may be placed on and secured around the mirror stem and rear of the vehicle with hook and loop fasteners such as Velcro®. It may take less than a minute to put the embodiment on and take off, when the scooter is parked.

An embodiment of the invention uses hook and loop for the closures which is more resistant to the weather and thus may last many years more. An embodiment may be half the size of currently available covers and made of a light weight material (70 denier nylon ripstop); therefore, it can be folded compactly and stored on the scooter. The embodiment has three steps to placing it on and taking it off the scooter. The embodiment protects the scooter from the environment because it will be used consistently when the scooter is in use, eliminating damage to the scooter from the sun, rain, tree sap, bird droppings, etc.

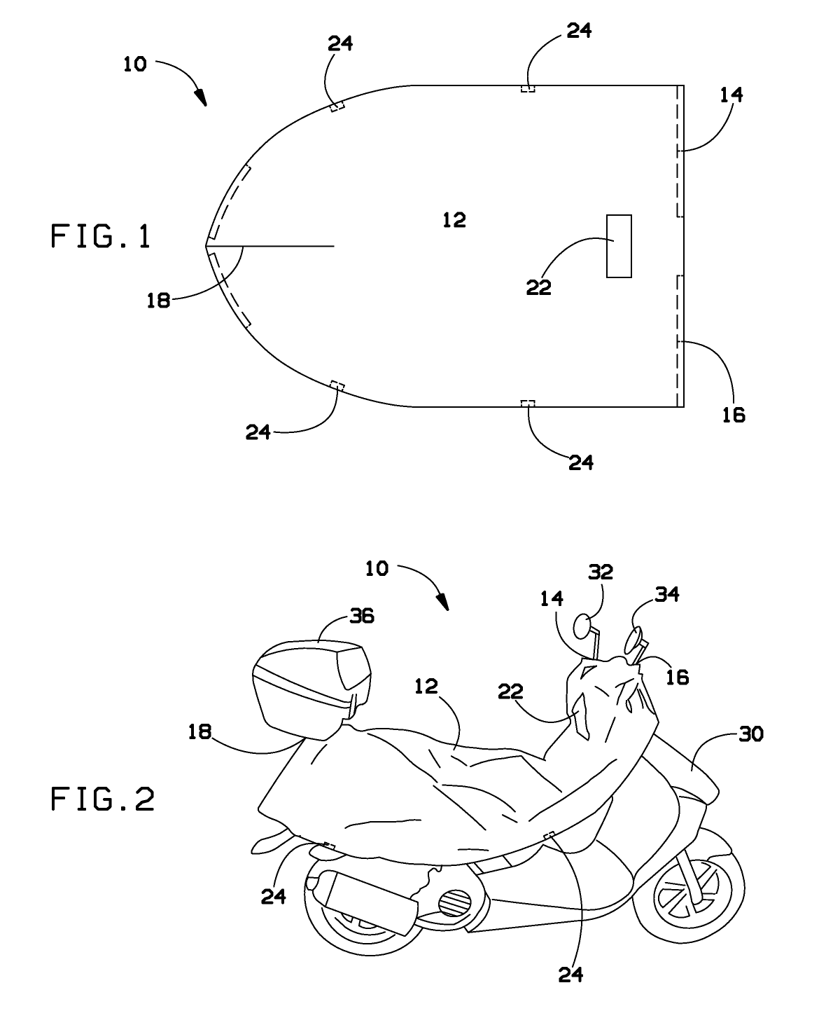

As depicted in FIG. 1, an embodiment of a scooter cape 10 may include a cover 12, mirror apertures 14 and 16, and a trunk aperture 18. The apertures 14, 16, 18 have fasteners, such as hooks-and-loops or Velcro®. The cover 12 has a size, including a total length 20. A centralized logo 22 helps align the cover 12, and silicon weights 24 at the sides help weight the cover 12 down. In an embodiment, the scooter may have an extension such as a rack or trunk, or there may be no trunk aperture 18 at all.

As depicted in FIG. 2, an embodiment of a scooter cape 10 protections an upper portion of a vehicle 30 having two mirrors 32 and 34, and a trunk 36. The lower portion of the vehicle 30, which is preferably a scooter, is exposed.

In an embodiment of the present invention, the steps of using the scooter cape may include the following:

Step #1. Measure scooter's size in length in order to purchase the correct size. Embodiments may be produced in a variety of colors and more sizes. The size of the scooter cape is determined by first placing the scooter on the stand or having the front tire in the forward (straight) position. Measure the length from the front of the front tire to the back of the back tire. Embodiments may be designed to fit most scooter sizes 50CC to 250CC, but determining the size is done by the length of the scooter, not the CC's. Sizes may include small/medium (fits 55 inches to 66 inches) and medium/large (fits 67 inches to 73 inches). Colors may include red and black.

Step #2. Place the embodiment over the handle grips and the braking handle. A logo on the embodiment may be seen on the instrument panel if it is positioned correctly. Next, adjust and center the hooks-and-loops such as Velcro® on the mirror stems and fold it closed around the mirror stems. The scooter cape may be attached to the mirror stems, and may cover vital parts of the scooter (i.e. brake handle, throttle). It may cover the instrument panel, and other vital parts.

Step 3. Close the cape securely around the rear of the scooter. Pull the material of the cape towards the back, covering the seat. A slit in the middle of the material may allow for the rear portion of the cape to be placed around racks, carriers, baskets, etc. This final closure is done with hooks-and-loops strips attached on either side of the material at the bottom edge. The embodiment flows from front to back, covering and protecting vital parts of the scooter.

An embodiment may be removed by undoing the hooks-and-loops in the front around the mirror stems and the back. This step may be done in any order. After removing the scooter cape it may be folded to the owner's desired shape and size. First, close the hooks-and-loops strips where the mirror stems would be. Then, it is recommended that the cape be folded first in the center, holding the scooter cape vertically with the longer length extending down. Next fold it in the center, horizontally, the bottom edge and the top edge should be together. Again fold it horizontally and once more. Next fold it in the center so the two sides come together. It may then be folded one or two more times depending on how compact you want it.

Towards the front and the back of the scooter cape on either side has attached a silicone weight displaying the trademark. This will help to ensure that the cape remains in place on windy days, protecting the scooter. The silicone will not scratch or damage the scooter. The embodiment may be folded and stored in any compartment the scooter provides.

The material make up of one embodiment is 70 denier nylon ripstop. An embodiment is a soft material that provides protection from damaging ultraviolet sunlight and keeping the seat cool. The material also keeps out bird dropping, soot, debris, and other forms of environmental pollution. The material may be water resistant, 100% nylon, mildew resistant, have tensile strength of 115 pounds, and resist ripping even if a hole is punctured into it.

Manufacturing of an embodiment may be done by computers using a digitized pattern. Other elements or steps to measure, put on, and take off the scooter cape may be done by humans. Computers may be used to digitize the patterns and cutting machines are used in the manufacturing of the scooter capes.

To use an embodiment, the scooter cape is placed on the scooter when it is not being used. Place the scooter up on the stand. Retrieve the embodiment from under the seat and place it over the scooter. First secure it to the mirror stems, having them centered and closing the hooks-and-loops tight. The logo is on the instrument panel, to indicate it is in the correct position for the next step. Then pull the scooter cape towards the rear and wrap it around the back. You then secure it by closing the hooks-and-loops snugly. Removing it is the reverse of putting it on. Fold it to its compact size and store it under the seat when finished.

It should be understood, of course, that the foregoing relates to exemplary embodiments of the invention and that modifications may be made without departing from the spirit and scope of the invention as set forth in the following claims.

We claim:

1. A device for a vehicle having an external mirror and a rear, comprising:
a cover to protect an upper portion of the vehicle;
a first aperture in the cover adapted for the mirror to pass through the first aperture;
a first attachment mechanism to secure the device to the vehicle proximate to the first aperture; and
a second attachment mechanism to secure the device to the vehicle proximate to the rear.

2. The device of claim 1, the vehicle further having a trunk adjacent the rear, the device further comprising:
a second aperture in the cover adapted for the trunk to pass through the second aperture.

3. The device of claim 1, wherein the attachment mechanism is a hooks-and-loops fastener.

4. The device of claim 1, wherein the vehicle is a scooter.

5. The device of claim 1, wherein the vehicle is a motorcycle, scooter, or bicycle, and the device exposes a lower portion of the vehicle.

6. The device of claim 1, wherein the cover is made of nylon.

7. The device of claim 1, further comprising:
a symbol on the cover to help align the cover with the vehicle.

8. The device of claim 1, further comprising:
a silicon weight on the cover to help retain the cover to the vehicle.

9. A method of protecting a two-wheeled vehicle, comprising:
measuring a size of the vehicle;
providing a cover adapted to fit the size of the vehicle, the cover having an aperture;
aligning the aperture with a mirror stem of the vehicle;
placing the cover over the vehicle; and
closing the cover;
thereby protecting the vehicle.

10. The method of claim 9, further comprising:
providing a second aperture in the cover; and
aligning the second aperture with an extension of the vehicle.
